(19) United States
(12) Patent Application Publication
(10) Pub. No.: US 2026/0221064 A1
(43) Pub. Date: Jul. 30, 2026

(54) PERCEPTUAL VISUAL DISTORTION CORRECTION ON A CURVED DISPLAY

(71) Applicant: Dell Products L.P., Round Rock, TX (US)

(72) Inventors: Ghee Beng Ooi, Singapore (SG); Dengzhai Xiong, Singapore (SG); Yao-Te Peng, Singapore (SG)

(73) Assignee: Dell Products L.P., Round Rock, TX (US)

(21) Appl. No.: 19/037,478

(22) Filed: Jan. 27, 2025

(51) Int. Cl. G09G 3/00; G06F 3/01; G09G 3/20; G09G 3/3208

(52) U.S. Cl. CPC G09G 3/03; G06F 3/012; G06F 3/013; G09G 3/2096; G09G 3/3208; G09G 2320/0261; G09G 2320/08; G09G 2340/04; G09G 2340/14; G09G 2354/00

(57) ABSTRACT

An information handling system presents visual images with a curved display that are corrected for perceptions related to peripheral versus binocular vision of an end user viewing the display. A binocular vision range is defined and scaled with a first scaling factor. A peripheral vision range is defined and scaled with a second scaling factor that compensates for perceptions of movement in an end user's peripheral vision with variable scaling factors applied to adjust for end user head position and gaze based upon detection of the end user by a camera capturing visual images of a viewing area of the display.

### BACKGROUND OF THE INVENTION

### Field of the Invention

The present invention relates in general to the field of information handling system displays, and more particularly to an information handling system curved display correction of perceptual visual distortion.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems process information with a processor that executes instructions in cooperation with a memory that stores the instructions and information. Stationary information handling systems, such as desktop, tower and server configurations, integrate processing components in a housing that operates at a fixed location with external resources, such as a power outlet and peripheral input devices. For instance, a typical stationary information handling system interfaces with a peripheral display to present information as visual images, a peripheral keyboard to accept key inputs and a peripheral mouse to accept cursor movement inputs. Portable information handling systems integrate the processor, memory, display, keyboard and a battery power source in a portable housing to support mobile operations. Portable information handling systems allow end users to carry a system between meetings, during travel, and between home and office locations so that an end user has access to processing capabilities while mobile. In addition to these integrated input/output devices, portable information handling systems will also typically interact with peripheral devices, such as a peripheral display.

Typical information handling system displays have a flat panel configuration to reduce the display thickness and weight. One type of flat panel display is a liquid crystal display (LCD) that presents images by changing the orientation of liquid crystals in a display panel to adjust the color of light that passes through the display panel from a backlight located behind the display panel. Another type of flat panel display has an organic light emitting diode (OLED) display film that generates illumination with a current applied to an organic material. Both types of displays render two dimensional content of text and graphics to an end user having a three dimensional space. With improving technology and reduced costs, flat panel displays have grown in size so that end users have a significant surface area to view visual images. One difficulty with these larger viewing surfaces is that the edges of the display are further away from an end user viewing the display at a middle position. As a result, some display panels have migrated towards a curved configuration about a central location where the end user is located. The curved configuration wraps the ends of the display viewing area towards the end user to reduce the end user's viewing distance relative to the center of the display viewing area.

One difficulty with curved displays is that the curvature of the display in three dimensional space impacts of an end user perceives the total visual image. As the display viewing area increases, with a head position in the center of the display, an end user's binocular vision focuses only on the center of display area so that the left and right curved edges of the display are perceived by the end user's peripheral vision. Humans have evolved to have peripheral vision that is more sensitive to movements than binocular vision. Human's acute sense to movement in the periphery means that content in peripheral vision appears to move faster than content in the binocular vision so that the edge content of a curved display appears to move faster than the central content. This perception distorts visual image presentation to create inaccuracies in actual perception versus the desired perception of visual images.

### SUMMARY OF THE INVENTION

Therefore, a need has arisen for a system and method which manages presentation of visual images in peripheral vision zones of curved displays.

In accordance with the present invention, a system and method are provided which substantially reduce the disadvantages and problems associated with previous methods and systems to manage display image presentations at a curved display. A variable scaling factor is applied to present visual images in a peripheral vision range with scaling that compensates for movement perceptions of peripheral vision.

More specifically, an information handling system processes information with a processor that executes instructions in cooperation with a memory that stores the instructions and information. The information is presented at a curved display as visual images defined in an array of pixels having a first scaling factor in a binocular vision range and a second scaling factor in a peripheral vision range. The second scaling factor adapts the presentation of visual images to correct for end user perceptions of increased movements in their peripheral vision.

The present invention provides a number of important technical advantages. One example of an important technical advantage is that a curved display presents visual images with a variable scaling factor that compensates for end user peripheral vision movement perceptions. Camera monitoring of end user viewing position, distance and eye gaze adjusts the variable scaling and moves the peripheral vision range as the direction of the end user's binocular vision range changes. EDID selection sets the curved display to present visual images with a single scaling factor when content does not involve movement in the peripheral vision range, and sets the curved display to enable the variable scaling factor when the content includes movement in the peripheral vision range.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system interfaced with a display that manages visual images presented in a peripheral vision image viewing zone;

FIG. 2 depicts an example embodiment of a curved display that manages visual image presentation in a peripheral vision image viewing zone;

FIG. 3 depicts a flow diagram of a process that manages visual image presentation in a peripheral vision image viewing zone;

FIG. 4 depicts a flow diagram of a process for switching EDID based on perceptual selection; and

FIG. 5 depicts a flow diagram of a process for end user seated distance detection and scaling for peripheral vision.

### DETAILED DESCRIPTION

An information handling system display manages presentation of visual images with a first scaling factor in an end user's binocular vision range and a second scaling factor in an end user's peripheral vision range to address end user perceptions of greater movement in peripheral vision. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

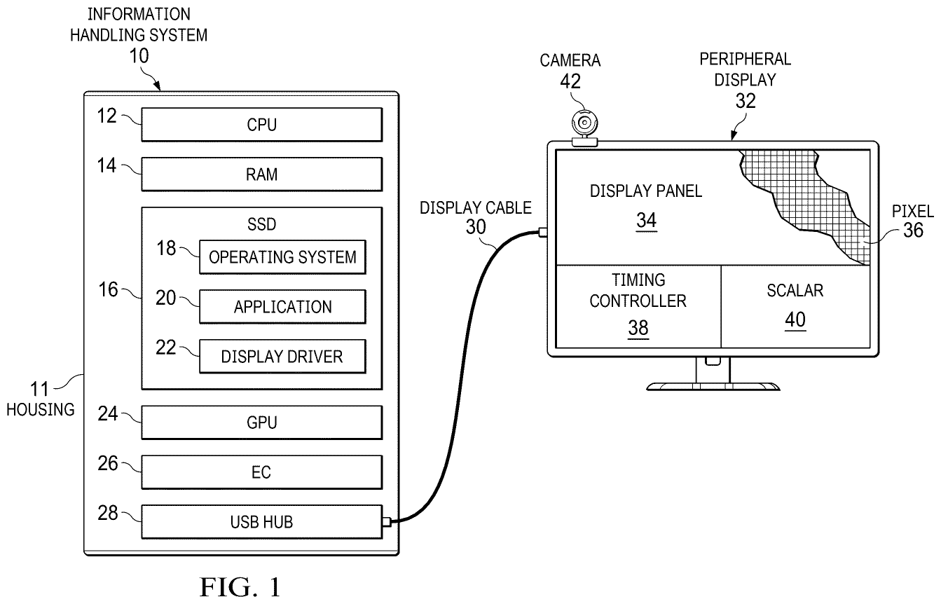

Referring now to FIG. 1, a block diagram depicts an information handling system 10 interfaced with a display 32 that manages visual images presented in a peripheral vision image viewing zone. Information handling system 10 processes information with processing components coupled in a housing 11. In the example embodiment, housing 11 has a stationary configuration that presents information as visual images at a peripheral display 32. In an alternative embodiment, information handling system 10 may have a portable configuration that integrates display 32 into housing 11 and also interfaces with a peripheral display. A central processing unit (CPU) 12 executes instructions to process information in cooperation with a random access memory (RAM) 14 that stores the instructions and information. A solid state drive (SSD) 16 provides non-transient memory that stores instructions and information during power down of the system. For example, an operating system 18 coordinates interactions between processing components and supports execution of applications 20. In the example embodiment, a display driver 22 executes in coordination with operating system 18 to present visual images at display 32. A graphics processing unit (GPU) 24 interfaces with CPU 12 to further process information to define visual images, such as by defining pixel values that are communicated to peripheral display 32 through a display cable 30. In alternative embodiments, GPU 24 may be included with CPU 12. An embedded controller 26 manages operational conditions within housing 11, such as application of power and interactions with peripheral devices. A USB hub 28 manages communication with external devices through USB communications.

Information handling system 10 presents information as visual images by generating pixel values that are communicated through a display cable 30 to a timing controller 38 and scanned to an array of pixels 36 of a display panel 34. A scalar 40 has a processing resource and non-transitory memory to manage operations at display 32, such as the resolution of visual images scanned by timing controller 38. For example, scalar 40 can adjust the resolution of visual images so that the scan of timing controller 38 matches the size of the pixel array of the display panel. In the example embodiment, visual images presented at display 32 are scaled to correct perceptions of movement speeds in the peripheral vision of an end user viewing the display panel and associated with a curved display panel surface. When visual images presented at the display panel have movement in a peripheral viewing area, GPU 24 and scalar 40 cooperate to apply a first scaling factor for visual images in the end user's binocular viewing area and a second variable scaling factor for visual images in the end user's peripheral viewing area. A camera 42 directed towards a viewing area of the display captures an image of the end user that is used to determine where the end user's peripheral vision is in effect. For instance, camera 42 captures an image of the end user head to detect end user viewing direction and head movement, and camera 42 also includes an infrared capability that detects distance to the end user and eye gaze direction based on pupil detection. Instructions stored in non-transitory memory, such as display driver 22 and/or scalar 40 embedded code, apply the display panel screen size (24″, 27″, 34″, 49″, etc.), the pixel density or resolution (HD 1920×1080, Quad HD 2560×1440, etc.), the display panel curvature (1500R, 1800R, 3000R, etc.), and the end user's position relative to the display panel to determine the variable scaling factor. A binocular vision range and peripheral vision range are defined where the first scaling factor is applied to visual images in the binocular vision range and the second variable scaling factor is applied to visual images in the peripheral vision range. The display panel curvature is analyzed to find a number of pixels equivalent to a flat panel and content is mapped for right and left peripheral vision zones to the equivalent flat panel content. The amplified resolution for the peripheral viewing zone is declared in Extended Display Identification Data (EDID) timing to source and the visual images are then scanned to the pixel array with the first scaling factor, such as a segmented fixed horizontal scaling factor, and the second scaling factor, such as a continuous variable scaling factor.

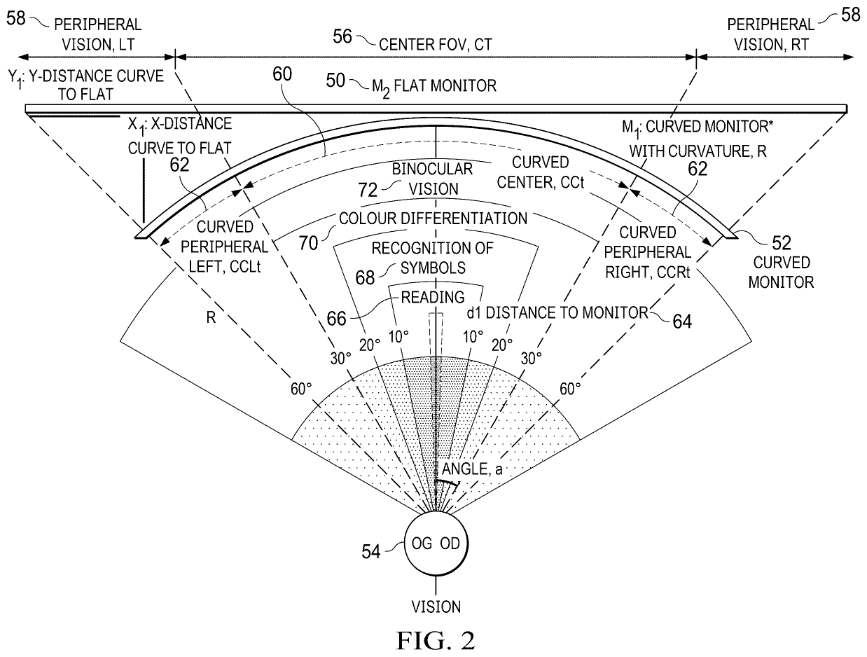

Referring now to FIG. 2, an example embodiment depicts a curved display 52 that manages visual image presentation in a peripheral vision image viewing zone 62. The example embodiment depicts various viewing zones at various angles when compared against a flat panel display 50 of the same viewing area that has no curvature. An end user head 54 is aligned to view the display with a zero to ten degree viewing angle on each side of a central axis providing a reading zone 66 at a first distance to the display panel. At a zero to twenty degree viewing angle out to a second distance a recognition of symbols zone 68 is where the end user vision can typically detect symbols. At a zero to thirty degree viewing angle out to a third distance a color differentiation viewing zone 70 is where the end user vision can typically detect color differences. In that same zero to thirty degree viewing angle out to a fourth distance, the end user has a binocular vision zone 72 in which both eyes cooperate to capture visual images. This central sixty degrees of viewing angle 56 is a binocular vision range 60 in the example embodiment for the example distance. Outside of the central viewing angle, a monovision viewing area 64 exists where only one eye captures visual images in a peripheral viewing angle 58. Within the monovision viewing area on the left side and the right side of the central binocular vision range, a peripheral vision range 62 exists in which an end user will capture visual images with peripheral vision that tends to have a perception of greater movement in the manner that the human eye and brain interpret captured visual images. The peripheral vision range on each side of the binocular vision range can change as the end user's head position and eye gaze change based upon monitoring by a camera. For instance, an end user gaze thirty degrees to the left would place the entire peripheral vision range on the right side of the display.

The example embodiment illustrates how curved display 52 shows an image that is equivalent to flat display 50, where the flat display has a greater length than the curved display. To adjust for presentation of visual images based on human perceptions, the peripheral vision area is represented as it would be on a two dimensional flat display panel. Since peripheral vision is more sensitive to motion than binocular vision, scaling to compress the image in the peripheral vision range essentially reduces the distance shown and thereby reduces the motion. Calculation of the binocular and peripheral vision ranges are performed based upon the curvature R of the curved display panel, the distance d between the end user and the display panel, the resolution of the display panel, its aspect ratio and the diagonal size of the display panel. In the example embodiment the central sixty degrees field of vision is the binocular vision range and the outer left and right side thirty degrees field of vision is the peripheral vision range. A distance between the end of the curved display and the flat display labeled X1 and the distance from end of the curved display to the end of the flat display labeled Y1 are used to scale the left and right peripheral vision areas of the ideal flat two dimensional display panel onto the peripheral vision range of the curved display panel. For a flat panel display panel M2 and curved display panel M1:

$$M 2 = 2 R tan ( M 1 / 2 R ) and M 2 Resolution = ( M 2 / M 1 ) * ( M 1 Resolution )$$

The center field of view screen length with a sixty degree center binocular vision range and curvature of R equals:

$$Center length = ( 60 / 3 \; 60 ) * 2 R$$

From the resolution and curvature with the sixty degree binocular vision range, the pixels in the center vision area equals:

$$Pcv = ( Curved Center / M 1 ) * M 1 resolution .$$

From the resolution and curvature with the thirty degrees of the peripheral vision range, the pixels in the left or right peripheral vision range Ppr equals:

$$Ppr = ( M 1 Resolution - Pcv ) / 2$$

Based on these calculations, the scaling in both the left and the right peripheral vision range to equal:

$$( M 2 Resolution - Pcv ) / ( M 1 Resolution - Pcv )$$

In summary, the center field of view Ct, the left peripheral vision Lt and the right peripheral vision Rt equals:

$$Ct = ( CCt / M 1 ) * M 1 Resolution$$

$$Lt = Rt = ( M 2 Resolution - PCV ) / 2$$

As is described above, these values change and may be calculated in real time based on the camera-determined distance and gaze of the end user. The camera analysis may include monitoring of head movements to adjust the locations at which the first and second scaling factors are applied.

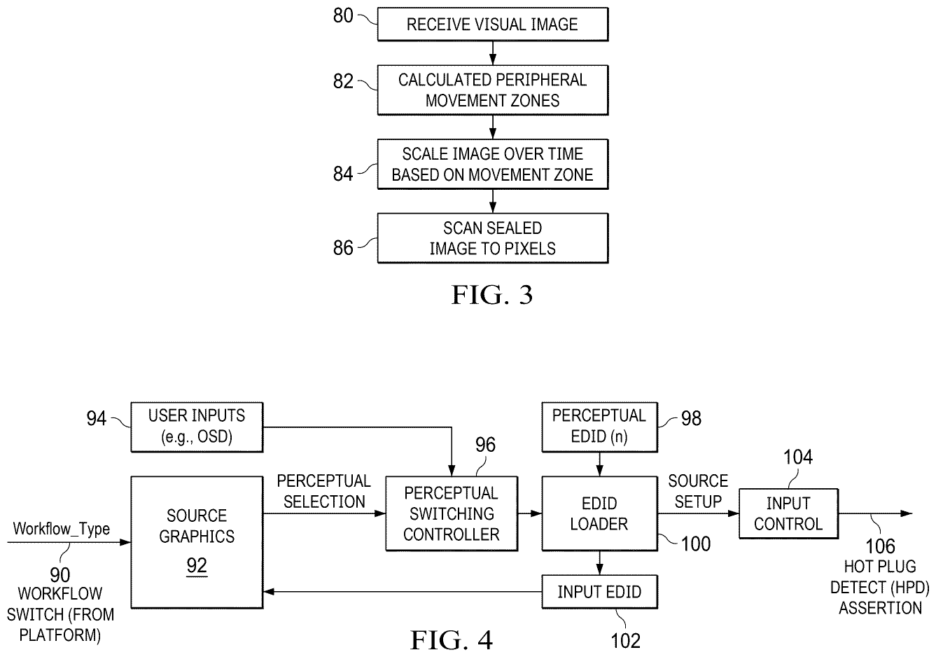

Referring now to FIG. 3, a flow diagram depicts a process that manages visual image presentation in a peripheral vision image viewing zone. The process starts at step 80 by receiving the visual image. The visual image scaling may be performed at a GPU and then communicated to a display, at a scalar within the display or at a combination of instructions executed by both the GPU and the scalar in cooperation with each other. In alternative embodiments, other types of processing components may be used, such as an application specific integrated circuit. At step 82 the peripheral movement zones are calculated, such as is described above. At step 84 the visual image is scaled based upon the movement zones so that movements presented in the peripheral movement zones are reduced, such as by compressing the visual images. At step 86, the visual image is scanned to pixels of the display panel for presentation of the end user.

Referring now to FIG. 4, a flow diagram depicts a process for switching EDID based on perceptual selection. The process starts at step 90 with a workflow switch from the information handling system communicated as a workflow_type to the source graphics at step 92. A user input is provided at step 94 that allows an end user to select whether to correct visual image presentation for movement perceptions of peripheral vision. At step 96 when an end user selects to correct for peripheral vision movement perception and a workflow type indicates content with peripheral movement that implies movement correction, a command is provided to an EDID loader 100 to load a peripheral movement perception EDID 98 to an input EDID 102, which is returned to the source graphics 92 to indicate the availability peripheral movement correction. At step 104 the perceptual EDID is provided to an input control 104 to issue a hot plug 106 detect assertion at the display that resets the display presentation.

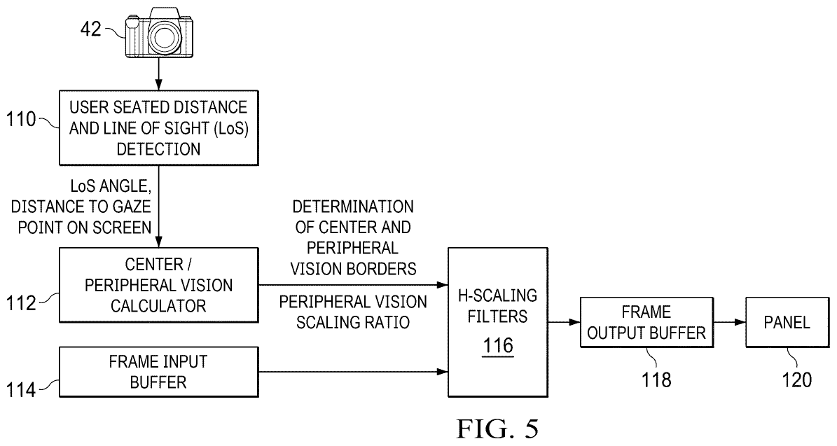

Referring now to FIG. 5, a flow diagram depicts a process for end user seated distance detection and scaling for peripheral vision. The process starts at a camera 42 that captures a visual image of an end user viewing the display to determine a user seated distance and line of sight at step 110. The line of sight angle, distance and gaze point are communicated to step 112 where the center/peripheral vision calculator determines the binocular vision range and the peripheral vision range for application of the first and second scaling factors. The determined binocular vision range, peripheral vision range and scaling factors are communicated for application by the scaling filters 116 to the visual image information of the frame input buffer 114. At step 118 the curved display pixel values are communicated to the display panel 120 for presentation to the end user with the peripheral vision range scaled to compress so that motion in the peripheral vision of the end user is adjusted for end user perception.

Although the present invention has been described in detail, it should be understood that various changes, substitutions and alterations can be made hereto without departing from the spirit and scope of the invention as defined by the appended claims.

What is claimed is:

1. An information handling system comprising:
a processor operable to execute instructions that process information;
a memory interfaced with the processor and operable to store the instructions and information;
a graphics processing unit interfaced with the processor and operable to render the information as pixel values that define visual images;
a display interfaced with the graphics processing unit and having a curved panel view area to present the visual images; and
a non-transitory memory storing instructions that when executed cause:
definition of a binocular vision range at the display;
definition of a peripheral vision range at the display;
mapping the visual images to the binocular vision range with first scaling factor;
mapping the visual images to the peripheral vision range with a second scaling factor that adjusts the first scaling factor to compensate for peripheral vision movement perception; and
presenting the visual images at the display with the first and second scaling factors.

2. The information handling system of claim 1 wherein the instructions execute at least in part on the graphics processing unit to adjust pixel values communicated to the display.

3. The information handling system of claim 1 further comprising:
a timing controller included in the display and operable to scan pixel values to pixels of the display; and
a scalar interfaced with the graphics processing unit and the timing controller, at least some of the instructions executed on the scalar to present the visual images with the first and second scaling factors to compensate for peripheral vision movement perception.

4. The information handling system of claim 1 further comprising:
extended display identification data (EDID) non-transitory storage included in the display and storing a first EDID code associated with presenting visual images with just the first scaling factor and a second EDID code associated with presenting visual images with both the first and second scaling factors; and
instructions stored in the non-transitory memory to command return of the first EDID code or second EDID code from the display based on a type of content to be presented at the display.

5. The information handling system of claim 1 further comprising:
a camera aligned to capture a visual image of an end user in a viewing area of the display; and
an instruction operable to adjust the binocular vision range and the peripheral vision range based upon the visual image of the end user.

6. The information handling system of claim 5 wherein the camera comprises a time of flight sensor that detects a range of the end user to the display.

7. The information handling system of claim 5 wherein the camera comprises an eye scan sensor that detects a pupil orientation of the end user relative to the display.

8. The information handling system of claim 5 wherein the camera detects rotation of the end user head.

9. The information handling system of claim 1 wherein the display comprises an organic light emitting diode display film.

10. A method for presenting visual images at a curved display, the method comprising:
defining a binocular vision range at the curved display;
defining a peripheral vision range at the curved display;
mapping the visual images to the binocular vision range with first scaling factor;
mapping the visual images to the peripheral vision range with a second scaling factor that adjusts the first scaling factor to compensate for peripheral vision movement perception associated with the curved display; and
presenting the visual images at the curved display with the first scaling factor in the binocular vision range and the second scaling factor in the peripheral vision range.

11. The method of claim 10 further comprising:
capturing a visual image of an end user viewing the curved display; and
applying the visual image to determine the binocular vision range and the peripheral vision range.

12. The method of claim 11 further comprising:
detecting rotation of a head of the end user in the visual image; and
in response to the rotation, moving the binocular vision range and the peripheral vision range.

13. The method of claim 11 further comprising:
detecting eye gaze movement of the end user in the visual image; and
in response to the eye gaze movement, moving the binocular vision range and the peripheral vision range.

14. The method of claim 11 further comprising:
detecting a distance of a head of the end user in the visual image; and
in response to the distance, adjusting the size of the binocular vision range and the peripheral vision range.

15. The method of claim 10 further comprising:
setting a first EDID code with the display when visual image content has greater than a first threshold of movement; and
setting a second EDID code with the display when visual image content has less than a second threshold of movement.

16. A system for presentation of visual images at a curved display, the system comprising:
a non-transitory memory storing instructions that when executed on a processing resource cause:
definition of a binocular vision range at the curved display;
definition of a peripheral vision range at the curved display;
mapping the visual images to the binocular vision range with first scaling factor;
mapping the visual images to the peripheral vision range with a second scaling factor that adjusts the first scaling factor to compensate for peripheral vision movement perception associated with the curved display; and
presenting the visual images at the curved display with the first and second scaling factors.

17. The system of claim 16 further comprising a graphics processing unit coupled in an information handling system and interfaced with the non-transitory memory to execute the instructions.

18. The system of claim 16 further comprising a scalar coupled in the curved display and interfaced with the non-transitory memory to execute the instructions.

19. The system of claim 16 further comprising:
a camera aligned to capture a visual image of an end user in a viewing area of the curved display; and
an instruction operable to adjust the binocular vision range and the peripheral vision range based upon the visual image of the end user.

20. The system of claim 19 wherein the camera detects a distance of an end user to the curved display, a gaze direction of the end user to the display and rotation of a head of the end user.
